(19) United States
(12) Patent Application Publication
(10) Pub. No.: US 2026/0264092 A1
(43) Pub. Date: Sep. 10, 2026

(54) HAND-HELD SPINNING CENTRIFUGAL MICROFLUIDICS SYSTEMS AND THE APPLICATIONS THEREOF

(71) Applicant: City University of Hong Kong, Hong Kong (HK)

(72) Inventors: Bee Luan KHOO, Hong Kong (HK); Wei LI, Hong Kong (HK)

(21) Appl. No.: 19/435,768

(22) Filed: Dec. 30, 2025

Related U.S. Application Data
(60) Provisional application No. 63/768,202, filed on Mar. 7, 2025.

(51) Int. Cl. B04B 5/04; B04B 5/10; B04B 13/00

(52) U.S. Cl. CPC B04B 5/0407; B04B 5/10; B04B 13/00

(57) ABSTRACT

A hand-held spinning centrifugal microfluidics system is provided for quantifying protein levels in biological samples. The system includes a spinning device and a centrifugal microfluidic chip disk having a hydrophobic upper layer and a hydrophilic bottom layer. The upper layer incorporates a reagent-loading chamber connected to multiple radially arranged reaction chambers through radial side-tubes. Each reaction chamber includes a venting and sample-loading opening for receiving biological samples. The radial side-tubes are constructed with a deliberate geometric transition to enhance local hydrophilicity and generate capillary pressure that prevents premature reagent flow before spinning. During operation, a colorimetric dye flows from the reagent-loading chamber into the reaction chambers. An illumination device provides uniform lighting, and an image acquisition module captures images of the resulting colorimetric reactions. A controller processes the images, extracts colorimetric intensity values, and determines the protein concentration by referencing a calibration curve derived from standard protein samples.

### CROSS-REFERENCE TO RELATED APPLICATIONS

The present application claims priority from U.S. Provisional Utility Patent application No. 63/768,202 filed Mar. 7, 2025; the disclosure of which is incorporated herein by reference in its entirety.

### FIELD OF THE INVENTION

The present invention generally relates to the field of microfluidics and medical devices. More specifically, the present invention relates to hand-held spinning centrifugal microfluidics systems.

### BACKGROUND OF THE INVENTION

Fluid-based diagnostic testing offers a non-invasive, low-cost, and practical approach for disease screening, diagnosis, and longitudinal health monitoring, providing advantages over more invasive or equipment-intensive methods, such as venous blood analysis. Abnormal elevations of protein in biological fluids—whether in urine, wound exudates, saliva, tear fluid, or other biofluids—serve as important indicators of pathological conditions, including renal disorders, metabolic diseases, inflammatory syndromes, and cardiovascular abnormalities. Clinical evaluation of such protein levels typically relies on accurate quantification of total protein or specific protein biomarkers within the fluid sample.

Conventional protein-quantification methods include dipstick assays, fluid protein-to-creatinine ratios, immunoassays, and 24-hour sample collection followed by laboratory-based spectrophotometric analysis. While dipstick tests enable rapid and convenient assessments, they provide only qualitative or semiquantitative information. In contrast, quantitative measurements—critical for precise patient stratification, disease staging, and personalized treatment—often require sophisticated analytical instrumentation, such as benchtop spectrophotometers or automated analyzers. These instruments require a stable electricity supply, trained personnel, and laboratory infrastructure, making them unsuitable for resource-limited, decentralized, or field-based settings where diagnostic capabilities are urgently needed. These limitations highlight an unmet need for diagnostic systems that are rapid, accurate, low-cost, and deployment-ready.

In response to these challenges, the World Health Organization has emphasized the development of point-of-care (POC) diagnostic platforms that meet the ASSURED criteria: Affordable, Sensitive, Specific, User-friendly, Rapid, Robust, Equipment-free, and Deliverable. A variety of biosensing technologies, including optical, magnetic, electrochemical, and colorimetric systems, have been explored to meet these requirements. Among them, microfluidics has gained significant traction due to its minimal sample volume requirements, high analytical efficiency, and compatibility with decentralized testing. Microfluidics enables the automated manipulation of fluids and the integration of analysis within compact devices. Although traditional microfluidic chips often rely on external pumps for fluid actuation, centrifugal microfluidics leverages rotational forces for pump-free fluid control. However, conventional centrifugal systems typically remain dependent on electrically powered motors, limiting their practicality in low-resource environments.

To overcome these barriers, the present invention provides a hand-held spinning platform incorporating a centrifugal microfluidic chip for quantitative protein measurement in diverse biological fluid samples using colorimetric algorithmic analysis. The device operates without electricity or external pumps, enabling truly portable, accessible, and low-cost diagnostic testing suitable for remote, resource-limited, and point-of-care environments.

### SUMMARY OF THE INVENTION

The objective of the present invention is to provide a system and method for solving the aforementioned technical problems.

In accordance with a first aspect of the present invention, a hand-held spinning centrifugal microfluidics system is provided. The handheld spinning centrifugal microfluidics system includes: a spinning device; a centrifugal microfluidic chip disk with an upper layer and a bottom layer; an illumination device configured to illuminate the reaction chambers; an image acquisition module configured to capture images of the illuminated reaction chambers; and a controller including one or more processors. The upper layer is hydrophobic and includes: a plurality of reaction chambers configured to accommodate a biological fluid sample, each reaction chamber comprising a venting and sample-loading hole for receiving the biological fluid sample; and a reagent-loading chamber comprising an introducing port configured to introduce a colorimetric dye, a container configured to retain the colorimetric dye, and a plurality of radial side-tubes connecting the reagent-loading chamber to the respective reaction chambers and configured to deliver the colorimetric dye into the reaction chambers. The reagent-loading chamber is located in the central region of the upper layer. The reaction chambers are arranged radially around the reagent-loading chamber, and the number of radial side-tubes equals the number of reaction chambers.

The bottom layer features a hydrophilic surface that forms the floor of the centrifugal microfluidic chip disk and is configured to promote the uniform spreading of the biological fluid sample and the colorimetric dye. The radial side-tubes feature a microchannel structure with a deliberate geometric transition from a high aspect ratio to a low aspect ratio, which increases local hydrophilicity and induces capillary pressure sufficient to prevent premature flow of the colorimetric dye before spinning.

The processors are configured to: control the illumination device to illuminate the reaction chambers; control the image acquisition module to obtain the images; extract one or more colorimetric intensity values from images of the reaction chambers; calibrate the extracted intensity values using a calibration curve established from standard protein samples; and determine a protein concentration in the biological fluid sample based on the calibration curve. The centrifugal microfluidic chip disk is detachably mounted on the spinning device, such that rotation of the spinning device generates a centrifugal force. As the centrifugal microfluidic chip disk spins, the colorimetric dye contained in the container flows into the reaction chambers via the radial side-tubes.

In accordance with one embodiment, the geometric transition involves a reduction in microchannel height, width, or both, thereby producing a higher capillary pressure downstream of the transition to regulate reagent flow.

In accordance with another embodiment, the deliberate geometric transition from the high aspect ratio to the lower aspect ratio, from the reagent-loading chamber towards the reaction chambers, creates a capillary bursting valve that retains the colorimetric dye within the reagent-loading chamber until the centrifugal force generated during spinning exceeds a predetermined threshold.

In accordance with yet another embodiment, the bottom layer includes a glass substrate that has been plasma-treated to enhance surface wettability.

In accordance with yet another embodiment, the upper layer is configured to inhibit lateral spreading of liquid along channel walls. It includes polydimethylsiloxane (PDMS), polyurethane, silicone elastomer, thermoplastic elastomer (TPE), and ethylene-vinyl acetate (EVA).

In accordance with yet another embodiment, the reaction chambers are configured to prevent back-flow by capillary retention induced by the hydrophobic-hydrophilic interface between the upper layer and the bottom layer.

In accordance with yet another embodiment, the calibration curve is a four-parameter logistic (4-PL) fitting curve generated using standard protein solutions spanning a concentration range of 0-2000 μg/mL.

In accordance with yet another embodiment, the standard protein solutions include a series of a desired protein diluted in the colorimetric dye at different concentrations.

In accordance with yet another embodiment, the controller is further configured to correct the extracted color intensities by subtracting blank-sample intensities to obtain calibrated absorbance values.

In accordance with yet another embodiment, the image acquisition module includes a camera positioned at a fixed distance above the centrifugal microfluidic chip disk.

In accordance with yet another embodiment, the controller selects the red channel of the captured images for quantitative analysis and color complementarity of the colorimetric dye.

In accordance with yet another embodiment, the spinning device includes a hand-pull ring that is configured to generate centrifugal pressure without the need for electrical power.

In accordance with a second aspect of the present invention, a method for quantifying the concentration of a desired protein using the aforementioned system is provided. The methods include the followings steps: applying a biological fluid sample to venting and sample-loading holes of the reaction chambers; introducing a colorimetric dye solution into the reagent-loading chamber; spinning the microfluidic chip to distribute the colorimetric dye solution into the reaction chambers; illuminating the reaction chambers using the illumination device and acquiring images using the image acquisition module; extracting colorimetric intensities and converting them into absorbance values; and applying a calibration curve established from standard desired protein samples to determine the protein concentration in the biological fluid sample.

In accordance with one embodiment, the desired protein reacts colorimetrically with the colorimetric dye solution.

In accordance with another embodiment, the spinning is performed manually using a hand-operated pull-ring mechanism to generate centrifugal forces exceeding the capillary bursting threshold of the microchannel aspect-ratio transition.

In accordance with yet another embodiment, the calibration curve is stored in the controller memory for real-time clinical testing.

In accordance with yet another embodiment, the biological fluid sample includes urine from a patient suspected of having proteinuria.

### BRIEF DESCRIPTION OF THE DRAWINGS

Embodiments of the invention are described in more details hereinafter with reference to the drawings, in which:

FIGS. 1A-1C depict the hand-held spinning centrifugal microfluidics system according to one embodiment of the present invention, in which: FIG. 1A illustrates a schematic diagram of the portable hand-held spinning centrifugal microfluidics system, where the centrifugal microfluidic chip disk is placed on a manually operated hand-held spinning device; FIG. 1B shows a 3D view of the spinning device, and FIG. 1C depicts a schematic diagram of the two-layer centrifugal microfluidic chip disk for efficient colorimetric analysis;

FIGS. 2A-2B depict the centrifugal microfluidics mold, in which: FIG. 2A is a 3D schematic diagram of the centrifugal microfluidics mold, and FIG. 2B depicts the schematics of the mold from a top view;

FIGS. 3A-3F depict the characterization of the hand-held spinning centrifugal microfluidics system operation and reagent distribution by colorimetric analysis, in which: FIG. 3A depicts a flowchart of the user procedure for the hand-held spinning centrifugal microfluidics system; FIG. 3B shows a schematic diagram of the microchannel structure of the centrifugal chip disk, including 16 reaction units designed for sample loading, reagent dispensing, and colorimetric assays; FIG. 3C depicts a schematic of one microchannel unit showing the effects of centrifugal forces during spinning, which overcome the bursting pressure to facilitate reagent distribution; FIG. 3D and FIG. 3E shows the photographs of the centrifugal chip disk, depicting the image after reagent loading (FIG. 3D) and after reagent distribution (FIG. 3E), demonstrating the uniform spreading of the solution across the reaction wells; and FIG. 3F depicts the uniformity analysis of the solution distribution in the 16 reaction wells assessed by measuring the transmittance of grayscale values, indicating a consistent reagent distribution with a low coefficient of variation;

FIGS. 4A-4B depict the illustration of centrifugal microfluidics, in which: FIG. 4A shows the top view and FIG. 4B shows the side view;

FIGS. 5A-5F depict the optimization of illumination and image-capture parameters for the hand-held spinning centrifugal microfluidics system, in which: FIG. 5A depicts the transmittance intensity of illumination from the illumination apparatus, demonstrating a progressive decrease in color intensity as the exposure time (ET) of the image acquisition module is reduced; FIG. 5B shows representative images of standard BSA samples acquired using the optimized parameters—an exposure time of 1/100 s and a sample volume of 5 μL; FIG. 5C depicts the inverse correlation between red-channel transmittance and BSA concentration across multiple ET settings; FIG. 5D shows the dynamic transmittance range in the red channel for different sample volumes under various ET conditions; FIG. 5E depicts the comparison of the transmittance of the red, green, and blue channels as a function of BSA concentration, showing a pronounced decrease in red-channel transmittance with increasing BSA levels, while the green and blue channels show minimal signal changes; and FIG. 5F shows the dynamic ranges of the red, green, and blue channels, confirming that the red channel exhibits the greatest dynamic range and is therefore most suitable for quantitative analysis;

FIGS. 6A-6B depict loading the sample (FIG. 6A) and the reagent (FIG. 6B) into the hand-held spinning centrifugal microfluidics system to test samples;

FIG. 7 depicts the representative images of the centrifugal chip disk of standards imaged under different exposure times (i.e., 1/400, 1/200, 1/50, 1/40, 1/30, 1/20, and 1/10 s);

FIGS. 8A-8C depict the representative images of the centrifugal chip disk of standards with a sample volume of 1.25 μL (FIG. 8A), 2.5 μL (FIG. 8B), and 10 μL (FIG. 8C), imaged under the exposure time of 1/100 s;

FIGS. 9A-9C depict the transmittance of the red channel with the BSA concentration increases under different exposure times, and the sample volumes of BSA are 1.25 μL (FIG. 9A), 2.5 μL (FIG. 9B), and 10 μL (FIG. 9C), respectively;

FIGS. 10A-10D depict the calibration of the system using BSA standards, in which: FIG. 10A illustrates the red channel transmittance measurements for standard BSA samples at various concentrations; FIG. 10B shows the calibration curve of the red channel absorbance versus standard BSA concentration; FIG. 10C depicts the linear dynamic range of the calibration curve for BSA detection, with the correlation coefficient (R²) and detection limit indicated on the plot; and FIG. 10D shows the stability analysis of standard protein samples, showing that the red channel transmittance remains stable over time (CV<6%);

FIG. 11 depicts the flowchart of the colorimetric algorithmic analysis procedures;

FIG. 12 depicts the calibration curve of standards detected by the plate reader with a detection limit of 22.53 μg/mL and linear dynamic ranges of 75.90-500 g/mL;

FIGS. 13A-13G depict the clinical testing and validation of the system for UTP Detection, in which: FIG. 13A depicts a flowchart outlining the procedure for clinical sample analysis using the system, including sample and reagent loading, device spinning for reagent distribution, and colorimetric readout captured with the optimized exposure time ( 1/100 s); FIG. 13B and FIG. 13C depict the measured urinary total protein (UTP) levels in samples from healthy donors (FIG. 13B) and post-MI patients (FIG. 13C); FIG. 13D shows a correlation analysis between the UTP concentrations obtained from the system and those obtained from the commercial plate reader; FIG. 13E depicts a Bland-Altman analysis comparing UTP results from the system and the commercial plate reader; FIG. 13F shows a boxplot comparing UTP concentrations between healthy donors and MI patients, and FIG. 13G depicts a receiver operating characteristic analysis that distinguishes healthy and MI patient samples based on UTP concentration, showing sensitivity, specificity, and area under the curve (AUC) values;

FIGS. 14A-14B depict the representative images of the colorimetric results detected from the healthy cohort (FIG. 14A) and the patient cohort (FIG. 14B);

FIGS. 15A-15B depict the clinical testing results of the UTP levels from healthy donors (FIG. 15A) and patients after myocardial infarction (MI) surgery (FIG. 15B) detected by a commercial plate reader; and

FIGS. 16A-16B depict the correlation analysis of clinical urine samples detected by the commercial plate reader, in which: FIG. 16A depicts a boxplot of UTP levels from healthy donors (n=6, 39.16±3.69 μg/mL) and patients after MI surgery (n=25, 288.08±172.95 μg/mL); FIG. 16B shows the corresponding received operator curves of FIG. 16A.

### DETAILED DESCRIPTION

In the following description, the systems of hand-held spinning centrifugal microfluidics systems and/or methods of quantifying a desired protein concentration, and the like, are set forth as preferred examples. It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

As used herein, the term “biological fluid sample” refers to any fluid derived from a biological organism, including but not limited to humans, that contains biomolecules, metabolites, proteins, cells, or other analytes of diagnostic interest. The term encompasses urine, blood, serum, plasma, saliva, tear fluid, sweat, cerebrospinal fluid, interstitial fluid, synovial fluid, sputum, wound exudate, mucus, lymphatic fluid, and cell culture media, as well as any processed, diluted, centrifuged, or otherwise treated derivatives thereof. A biological fluid sample may be obtained through non-invasive, minimally invasive, or invasive procedures and may be used directly or after pre-treatment for analytical, diagnostic, or monitoring purposes.

In accordance with a first aspect of the present invention, the present invention provides a hand-held spinning centrifugal microfluidics system designed for rapid, electricity-free biochemical testing, handy for quantifying protein levels in biological fluid samples. The system integrates a compact spinning device with a specially engineered centrifugal microfluidic chip disk that includes an upper hydrophobic layer and a bottom hydrophilic layer. The upper layer incorporates a plurality of reaction chambers, each configured to receive a biological fluid sample and equipped with a venting and sample-loading hole to facilitate sample introduction and proper air displacement during operation. Centrally located within the upper layer is a reagent-loading chamber featuring an introducing port for adding a colorimetric dye, a container region for storing the dye before testing, and a series of radial side-tubes that extend outward to connect directly to each of the reaction chambers. These radial side-tubes serve as delivery conduits that transfer the colorimetric dye into the reaction chambers during spinning. The reaction chambers are arranged radially around the central reagent-loading chamber, with the number of reaction chambers matching the number of radial side-tubes.

The bottom layer of the chip features a hydrophilic surface, such as a plasma-treated glass substrate, which serves as the floor of the disk and facilitates the uniform spreading of both biological fluid samples and the colorimetric dye. In contrast, the upper layer is hydrophobic. It may be composed of materials such as polydimethylsiloxane (PDMS), polyurethane, silicone elastomer, thermoplastic elastomer (TPE), or ethylene-vinyl acetate (EVA), all of which inhibit undesirable lateral spreading of sample solutions along the channel walls. The system also incorporates a deliberate geometric transition within the radial microchannels, shifting from a higher aspect ratio to a lower aspect ratio. This structural transition increases local hydrophilicity and generates capillary pressure sufficient to retain the colorimetric dye within the central reagent-loading chamber. The transition effectively forms a capillary bursting valve: dye remains stationary until centrifugal force applied during spinning overcomes the bursting pressure, thereby initiating controlled flow into the reaction chambers. Once the chip disk is mounted on the spinning device and the ring-pull mechanism is actuated, the device generates enough centrifugal force to drive the colorimetric dye through the radial side-tubes and into the respective reaction chambers.

To ensure reliable sample containment and analytical performance, the reaction chambers are designed to prevent back-flow using capillary retention at the hydrophobic-hydrophilic interface formed between the upper and lower layers. An illumination device is incorporated into the system to uniformly illuminate the reaction chambers after the colorimetric dye has reacted with the biological fluid sample. Positioned a fixed distance above the chip disk, an image acquisition module-such as a camera-captures images of the illuminated reaction chambers. The controller, equipped with one or more processors, governs the illumination device and the image acquisition module, extracts colorimetric intensity values from the captured images, and performs computational processing to achieve quantitative analysis.

The controller processes the captured images by selectively evaluating the red color channel, which offers the strongest correlation with the absorbance characteristics of the colorimetric dye. Extracted color intensities are corrected by subtracting the intensities of blank samples, thereby generating calibrated absorbance values that compensate for background noise or inter-assay variability. The system determines protein concentration by applying these calibrated values to a pre-established calibration curve. The calibration curve—preferably based on a 4-PL model—is generated using standard protein solutions spanning concentrations from 0 to 2000 μg/mL. These standard protein solutions consist of a series of dilutions prepared by mixing known quantities of a target protein with the same colorimetric dye used during testing. By fitting the calibrated intensities to the 4-PL function, the controller obtains precise concentration estimates for unknown clinical or biological fluid samples.

In summary, the hand-held spinning centrifugal microfluidics system combines carefully engineered fluidic structures—including aspect-ratio-modulated microchannels, hydrophobic/hydrophilic material interfaces, capillary bursting valves, and radially distributed reaction chambers—with integrated optical and computational components. The result is a compact, electricity-free analytical platform capable of rapidly and accurately quantifying protein concentrations using minimal sample volume, making it particularly suited for point-of-care diagnostics and operation in resource-limited environments.

In accordance with a second aspect of the present invention, the present invention further provides a method for quantifying the concentration of a desired protein using the aforementioned hand-held spinning centrifugal microfluidics system. In operation, the biological fluid sample to be analyzed is first applied directly to the venting and sample-loading holes of the reaction chambers on the microfluidic chip, allowing the sample to enter and occupy each designated chamber. A colorimetric dye solution is then introduced into the central reagent-loading chamber through its introducing port, where the dye is temporarily retained by the capillary bursting valve formed by the microchannel aspect-ratio transition. Once both the sample and dye are loaded, the microfluidic chip is mounted onto the spinning device, and spinning is initiated manually using a hand-operated pull-ring mechanism. Activation of the pull-ring produces sufficient centrifugal force to exceed the bursting threshold imposed by the geometric transition within the microchannels, thereby driving the colorimetric dye solution uniformly from the reagent-loading chamber through the radial side-tubes and into the reaction chambers, where it mixes with the biological fluid sample.

As the biological fluid sample and dye interact within the reaction chambers, the desired protein undergoes a colorimetric reaction with the colorimetric dye solution, resulting in measurable changes in optical intensity. To capture these changes, the illumination device is activated to uniformly illuminate the reaction chambers, and the image acquisition module, positioned at a predefined distance above the microfluidic chip, captures one or more images of the illuminated chambers. From these images, the controller extracts the colorimetric intensities corresponding to the reaction wells, converting these intensities into absorbance values based on the selected color channel. These absorbance values are then processed by applying a calibration curve that has been pre-established using standard samples of the desired protein. The calibration curve, stored in the controller's memory for real-time analytical use, correlates known protein concentrations with their respective calibrated absorbance values, allowing for the accurate calculation of protein concentration in the unknown biological fluid sample.

The method applies to a wide range of clinically relevant biological fluids, and in certain embodiments, the biological fluid sample comprises urine obtained from a patient suspected of having proteinuria. By combining manual centrifugal actuation with optical detection and calibrated quantitative analysis, this method enables rapid, reliable, and instrument-free quantification of protein concentration in field settings, resource-limited environments, and point-of-care diagnostic workflows.

### EXAMPLES

### Example 1. Development and Functionality of the Hand-Held Spinning Centrifugal Microfluidics System for Diagnostic Testing in Resource-Limited Environments

In one embodiment of the present invention, an affordable hand-held spinning centrifugal microfluidics system is provided to support POC diagnostic testing. The system is designed to deliver rapid and sensitive results while remaining user-friendly and fully operable without complex or electrically powered equipment, making it particularly well-suited for decentralized or resource-limited settings.

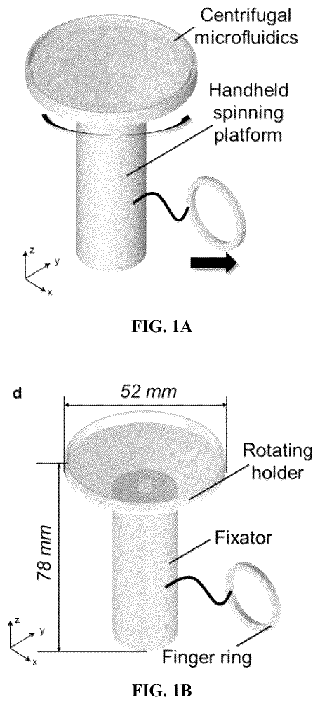

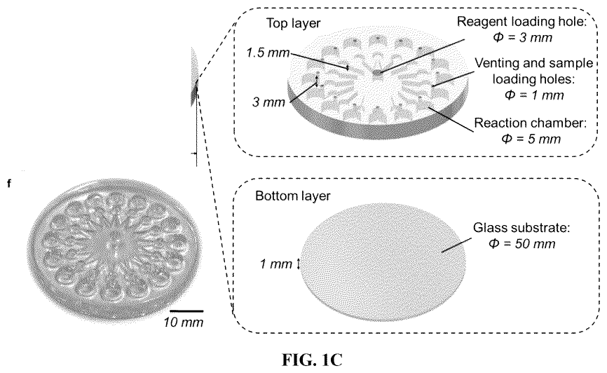

The hand-held spinning centrifugal microfluidics system includes a manually operated spinning device and a disposable centrifugal microfluidic chip disk optimized for automated colorimetric assays (FIG. 1A). The spinning device is compact—for example, approximately 52 mm in diameter and 78 mm in height (FIG. 1B). During operation, the centrifugal microfluidic chip disk is placed on the 3D-printed spinning device. When the rotor is manually actuated, centrifugal force evenly distributes the reagent solutions across the microfluidic chip and into each reaction well, thereby facilitating the colorimetric assay. This combination of portability, simplicity, and low cost enables efficient diagnostic testing in the absence of conventional laboratory infrastructure.

The centrifugal microfluidic chip disk is a two-layer structure engineered to support efficient colorimetric absorbance detection (FIG. 1C). The upper layer includes a reagent-loading chamber port for introducing a colorimetric dye, and multiple reaction chambers where colorimetric reactions occur. Each reaction chamber contains a venting and sample-loading hole that maintains air pressure balance during spinning and facilitates loading of test samples. These venting holes additionally function as sample-introduction ports.

In some embodiments, the two-layer chip has a diameter of 50 mm, a height of approximately 4 mm, and contains 16 reaction chambers. Each venting hole has a diameter of approximately 500 μm.

The reagent reservoir is designed to hold approximately 400 μL of solution, and the 16 reaction chambers receive the assay solution, generating colorimetric readouts. Microchannels connecting these chambers have widths and heights of roughly 500 μm. These microchannel patterns are formed using customized 3D-printed molds, followed by PDMS casting and curing. This fabrication strategy enables precise fluid manipulation and highly reproducible colorimetric analysis.

The bottom layer of the chip is a flat glass substrate that provides a hydrophilic surface, promoting uniform solution spreading. By contrast, the PDMS top layer presents a hydrophobic surface that prevents undesired solution climbing within the microchannels. Through careful control of the microchannel aspect ratio, fluid flow can be precisely regulated or restricted as required for accurate operation.

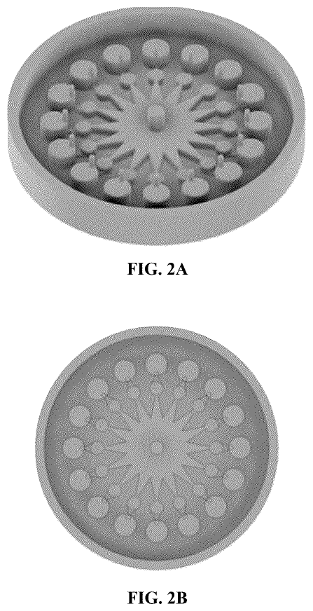

In one embodiment, the spinning device measures approximately 52 mm×52 mm×78 mm (length×width×height) and weighs about 10 g. The microfluidic chip molds are 3D-printed (FIGS. 2A-2B) and baked for more than 12 h to remove residual support materials. Chip fabrication is carried out using soft lithography. A PDMS mixture (10:1 elastomer-to-curing-agent ratio) is poured into the molds, degassed under vacuum to remove air bubbles, and cured at 70° C. for 2 h. The cured PDMS layer, containing reagent-loading ports, venting holes, solution wells, and sample-reaction chambers, is then peeled from the mold. The glass bottom layer is treated to enhance hydrophilicity, and both layers undergo plasma activation (3 min at 700 mmtor) before bonding. The assembled two-layer structure is then baked at 70° C. for 2 h to ensure strong adhesion.

During operation, clinical samples are pipetted into the sample wells, allowing up to 16 samples to be processed simultaneously. The colorimetric reagent (e.g., Coomassie Brilliant Blue G-250 dye) is introduced into the central reagent chamber and subsequently distributed into all sample wells during spinning. Ventilation microholes (~500 μm) allow air exchange and facilitate sample entry. After loading, the assembled chip is mounted onto the hand-held spinning device. Pulling the hand-actuated ring rotates the platform, ensuring even distribution of the reagent. Following a reaction time of approximately 3 min, the chip is transferred to an illumination device, and an image acquisition module captures the resulting colorimetric signals. Quantitative protein concentration is then derived through digital image analysis.

In some embodiments, the image acquisition module is a smartphone camera.

For each assay, a controlled illumination apparatus is used to maintain consistent lighting, and a standardized imaging protocol is applied to capture the colorimetric output. A Bayer filter integrated in the image acquisition module provides reliable optical imaging and accurate color reproduction. Critical imaging parameters include exposure time, ISO, and white balance. White balance is set to automatic mode to maintain equal intensity across red, green, and blue channels. The camera ISO is minimized (e.g., ISO 25) to reduce sensor noise, while the exposure time is varied between 1/10 and 1/6400 s to optimize signal sensitivity. Optionally, an enclosed imaging setup may be used to eliminate ambient light variability and standardize the field of view.

In one embodiment, the hand-held spinning centrifugal microfluidics system is used to quantify urinary total protein (UTP) in urine samples. Protein quantification is performed using a commercial Bradford colorimetric assay kit (PC0010, Solarbio) according to the manufacturer's instructions. The protein detection range is adjusted based on the sample-to-reagent ratio, and the Coomassie dye is diluted to working concentration. The assay range spans 0-2000 μg/mL, encompassing clinically relevant urinary protein concentrations, including those of albumin (>300 μg/mL). After a 3-min reaction with the Coomassie dye, the solution undergoes a visible color shift from brown to blue, indicating formation of a protein-dye complex. The image acquisition module captures an image of the chip disk, and an image-processing algorithm embedded in a processor extracts colorimetric information. The intensity of blue coloration correlates with protein concentration, and calibration curves generated from known standards establish the quantitative relationship between color intensity and protein levels.

### Example 2. Operational Validation and Uniformity Analysis of Reagent Distribution in the Hand-Held Spinning Centrifugal Microfluidics System

The hand-held spinning centrifugal microfluidics system is developed as a POC device for detecting and monitoring proteinuria, with particular suitability for deployment in remote and resource-limited environments. This system offers a cost-effective and rapid diagnostic solution, providing user-friendly operation and functionality that is entirely independent of external power sources.

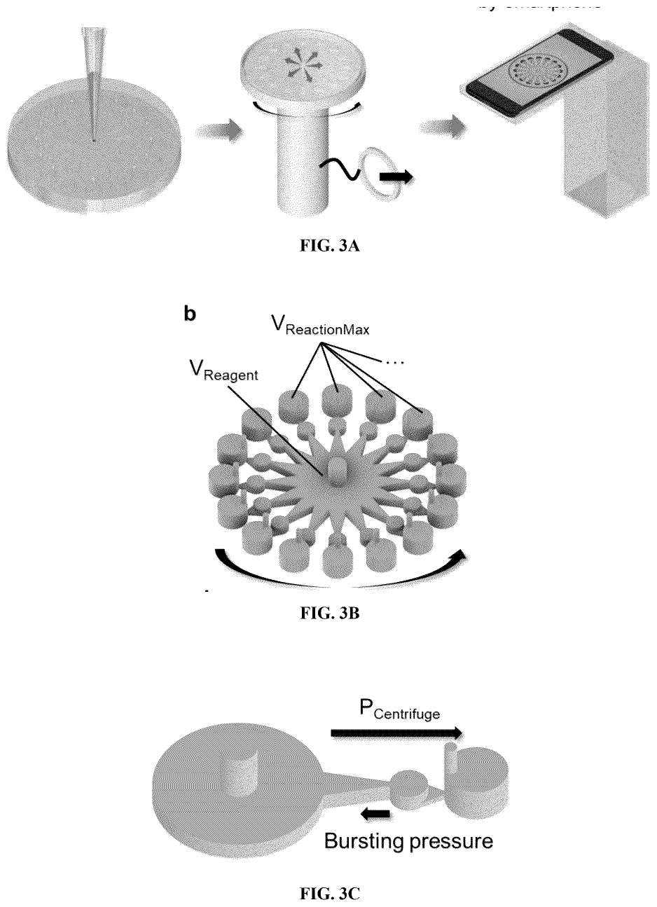

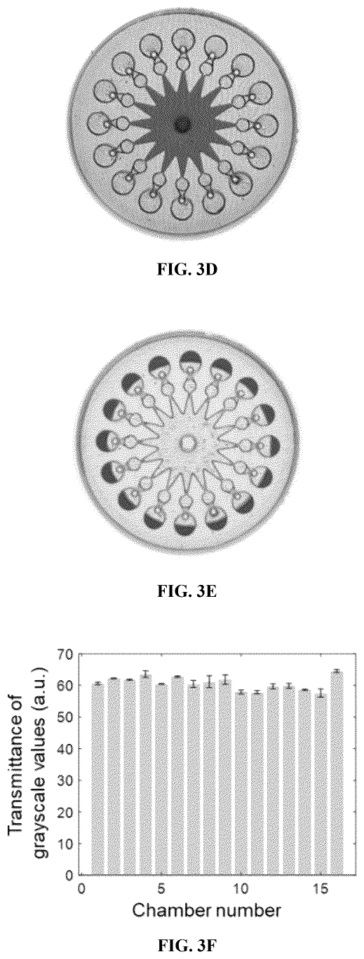

To evaluate the spatial distribution behavior of solutions within the hand-held spinning centrifugal microfluidics system, the primary operational steps are examined, including: (i) reagent loading, (ii) manual spinning, and (iii) optical result readout (FIG. 3A). Initially, the colorimetric reagent is introduced into the reagent-loading chambers, followed by placement of the microfluidic chip onto the spinning device. After a brief manual spin, the reagent is rapidly dispensed into all 16 reaction chambers within seconds, initiating reactions with the preloaded samples in each chamber. Following an incubation period of approximately 3 minutes, the color intensities in each reaction well are quantitatively measured using the image acquisition module.

The UTP chip includes 16 integrated units designed for sample loading, reagent dispensing, and biochemical reaction processing (FIG. 3B). After reagent loading, the dispensed volume can be estimated using the following equation:

$${V}_{R e a gent} = n {h}_{1} {R}_{1}^{2} sin ( \frac{180 °}{n} ) ( 1 + \frac{sin \frac{180 °}{n}}{tan {α}_{1}} ) . \qquad ( 1 )$$

The maximum reaction-chamber volume, V_{ReactionMax}, is similarly expressed by the equation:

$${V}_{R eactionMax} = n {h}_{2} {R}_{4}^{2} [ π - \frac{2 π {cos}^{- 1} \frac{{R}_{4} - 2 {R}_{3}}{{R}_{4}}}{360 °} + \frac{1}{2} sin ( 2 {cos}^{- 1} \frac{{R}_{4} - 2 {R}_{3}}{{R}_{4}} ) ] . \qquad ( 2 )$$

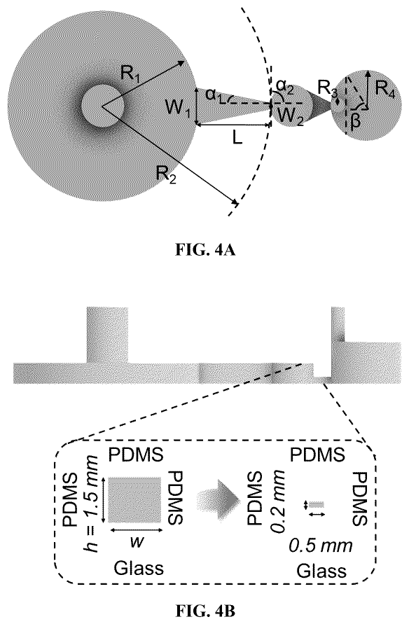

In these equations (equations (1)-(2)), n represents the number of distribution channels (n=16), h denotes the channel height (h₁=1.5 mm; h₂=3 mm), R₁ reflects a partial radius of the sample chamber, and R₃ and R₄ correspond to the vent-hole and reaction-chamber radii, respectively (R₃=0.5 mm; R₄=2.5 mm). The tangential angle of the sidewalls, α₁, is 11.55° (FIG. 4A). The total combined volume of all reaction chambers (V_{ReactionMax}=808 μL) exceeds the reagent-loading volume (V_{Reagent}=412 μL) to ensure that reaction solutions do not splash from the vent holes during operation.

The distribution process comprises two main stages. In the first stage, test samples and reagent solutions are manually loaded into their designated chambers. The capillary bursting valves initially restrict fluid movement. The bursting pressure of these valves is calculated using the following expression:

$$B P = - γ \{ \frac{cos {φ}_{AGlass} + cos {φ}_{APDMS}}{{h}_{1}} + \frac{2 cos [ min ( {φ}_{APDMS} + {α}_{1} + {α}_{2} ) , 180 ° ]}{{W}_{2}} \} ; \qquad ( 3 )$$

where y is the surface tension of the liquid (γ=0.072 N/m for water), φ_{AGlass} is the advancing contact angle on the glass substrate (16.8±3.2°), φ_{APDMS} is the advancing contact angle on the PDMS surface (125±2°), and W₂ and h₁ refer to the width and height of the diverging microchannel section (W₂=0.5 mm; h₁=1.5 mm). α₁ and α₂ are the sidewall angles (α₁=11.55°, α₂≈90°).

To overcome the bursting-valve restriction and initiate reagent movement into the reaction chambers, centrifugal force is applied by actuating the hand-held spinning platform (FIG. 3C). The centrifugal force is defined as:

$${P}_{Centrifuge} = \frac{1}{2} ρ {ω}^{2} {R}_{2}^{2} . \qquad ( 4 )$$

Where ω denotes the angular velocity generated by the manual spinning motion, and R₂ is the radial distance between the liquid and the rotational center (R₂=11.78 mm; FIG. 4A). During spinning, centrifugal pressure exceeds the bursting pressure threshold, thereby allowing the reagent and biological fluid samples to flow into the reaction chambers.

To prevent unwanted solution splashing at the sample-loading holes, the microchannel network incorporates a deliberate geometric transition from a higher aspect ratio to a lower aspect ratio, thereby increasing local hydrophilicity (FIG. 4B). This structural modification shifts the dominant capillary forces from the lateral channel walls to the top and bottom surfaces. The hydrophilic behavior of the glass substrate thus exerts greater influence than the hydrophobic PDMS top layer, ensuring stable reagent-sample mixing and retention within the reaction chambers.

To experimentally evaluate the spatial distribution of the reagent, a blue dye is injected through the inlet (FIG. 3D) and allowed to flow through the microchannels. After spinning, the dye is distributed into the reaction chambers (FIG. 3E). Visual inspection reveals uniform coloration across all 16 reaction wells.

Quantitative grayscale analysis (FIG. 3F) confirms this observation, with consistently low standard deviation values (60.67±2.00) and a low coefficient of variation (3.30%). These results indicate that the hand-held spinning centrifugal microfluidics system provides highly uniform solution distribution, a prerequisite for accurate and reliable colorimetric quantification.

### Example 3. Calibration of the Parameters of the Image Acquisition Module for Quantitative Analysis in the Hand-Held Spinning Centrifugal Microfluidics System

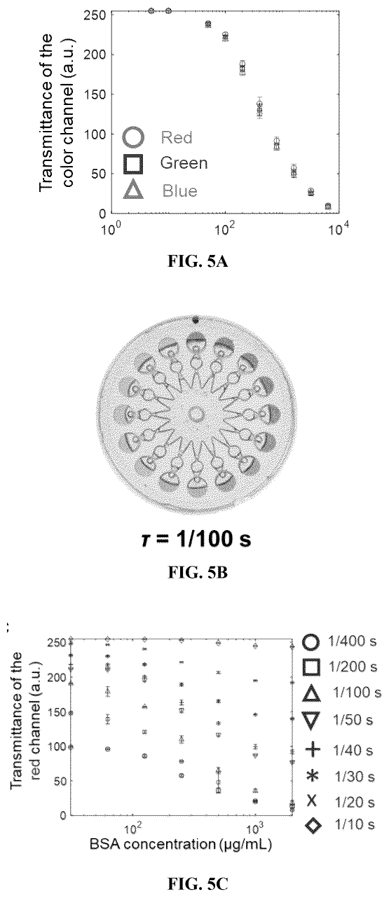

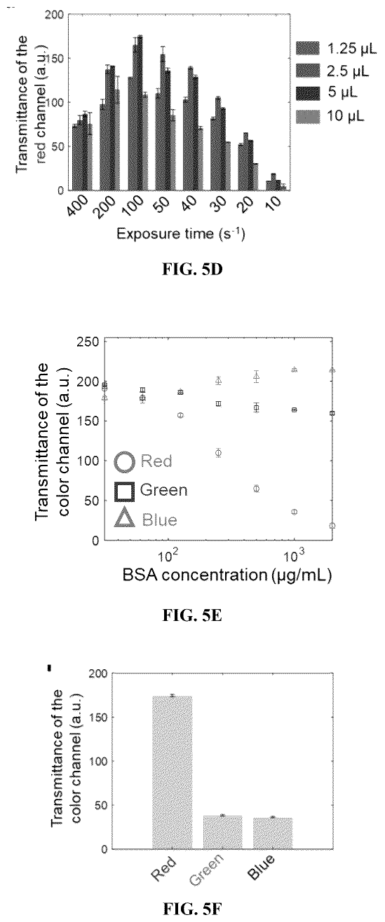

To optimize the exposure time (ET) and color-channel selection for the image acquisition module, an analysis of the color intensity emitted by the illumination apparatus is first conducted (FIG. 5A). The illumination apparatus is operated at its maximum output intensity to minimize environmental interference during ET optimization. A series of ten ET settings— 1/6400, 1/3200, 1/1600, 1/800, 1/400, 1/200, 1/100, 1/50, 1/10, and ⅕ s—are evaluated using the image acquisition module. The consistent intensity profiles across the red, green, and blue channels, along with minimal standard deviations, indicate highly stable and uniform illumination. At longer ETs (⅕ s and 1/10 s), channel saturation occurs, with recorded color intensities reaching 255, resulting in overexposed images that appear pure white. In contrast, shorter ETs yield progressively lower color intensities due to reduced photon capture by the image sensor.

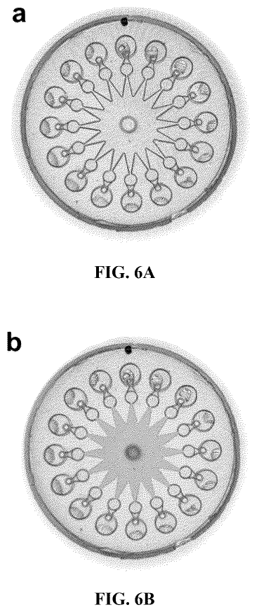

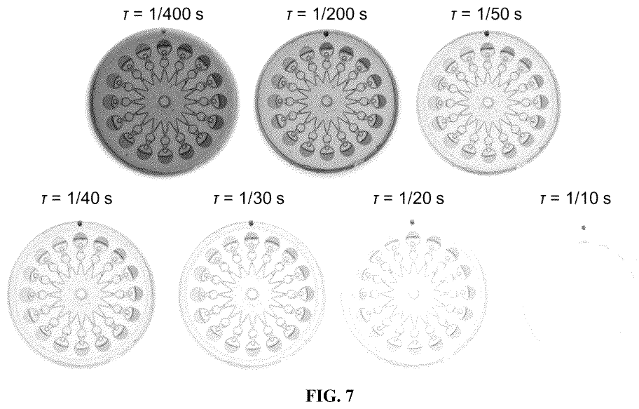

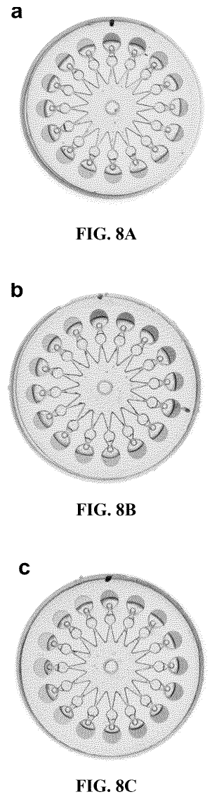

To determine optimal imaging parameters, eight standard BSA samples at concentrations of 2000, 1000, 500, 250, 125, 62.5, 31.25, and 0 μg/mL (blank) are prepared using the G250 reagent and loaded into the microfluidic chip disk (FIGS. 6A-6B). Images of these samples are acquired under ET settings of 1/400, 1/200, 1/100, 1/50, 1/40, 1/30, 1/20, and 1/10 s to identify the ET that provides the best analytical performance (FIG. 5B and FIG. 7). In parallel, BSA standards with sample-loading volumes of 1.25 μL, 2.5 μL, 5 μL, and 10 μL are assessed to determine the optimal sample volume (FIG. 5B and FIGS. 8A-8C).

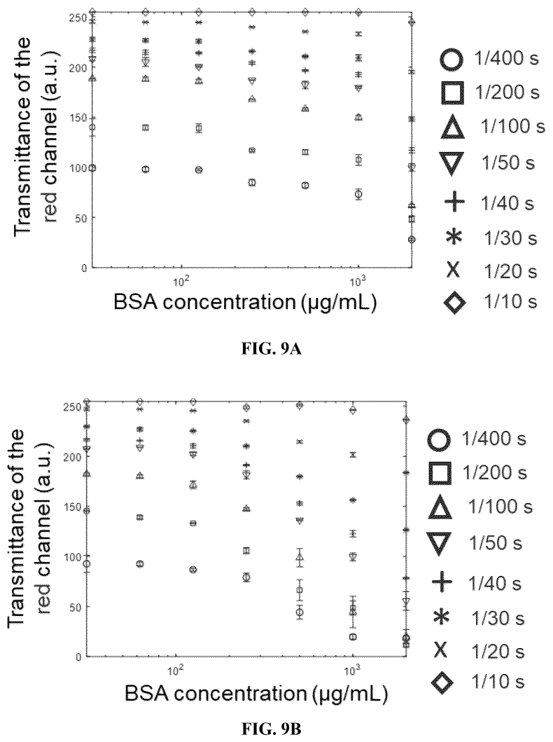

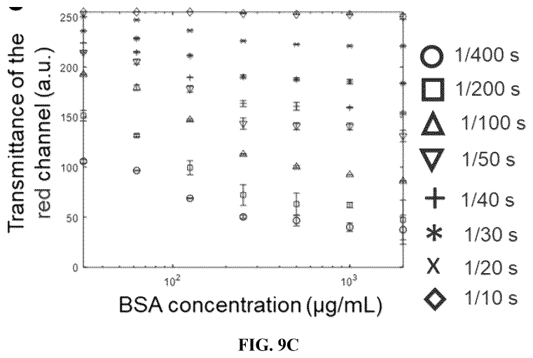

Quantification of color intensity in the reaction wells is performed by extracting the red-channel transmittance from each captured image (FIG. 5C and FIGS. 9A-9C). A clear inverse relationship is observed between BSA concentration and red-channel transmittance: higher protein concentrations result in lower transmittance, corresponding to higher optical absorbance. The dynamic range of transmittance varies across different ET conditions (FIG. 5D). Among the ETs evaluated, 1/100 s provides the most extensive dynamic transmittance range (143.82±26.87) across sample volumes, identifying it as the optimal ET for sensitive detection. Additionally, a sample volume of 5 μL yields the highest dynamic transmittance range (174.33±1.49), outperforming both lower and higher volumes, and establishes 5 μL as the optimal loading volume for subsequent analyses.

Transmittance values from the green and blue channels are also evaluated and compared to the red-channel data (FIG. 5E). However, the green and blue channels exhibit greater variability and substantially narrower dynamic ranges. In contrast, the red channel demonstrates the broadest dynamic range (174.33±1.49) and the strongest correlation between transmittance and analyte concentration (FIG. 5F). These findings align with the Beer-Lambert law and color-complementarity principles, supporting the selection of the red channel for quantitative analysis of urinary total protein (UTP). In summary, the optimized imaging parameters for the system are: the red color channel, an exposure time of 1/100 s, and a sample volume of 5 μL, which collectively provide maximum sensitivity and accuracy for colorimetric quantification using the image acquisition module.

### Example 4. Calibration and Sensitivity Characterization of the Hand-Held Spinning Centrifugal Microfluidics System for Protein Detection

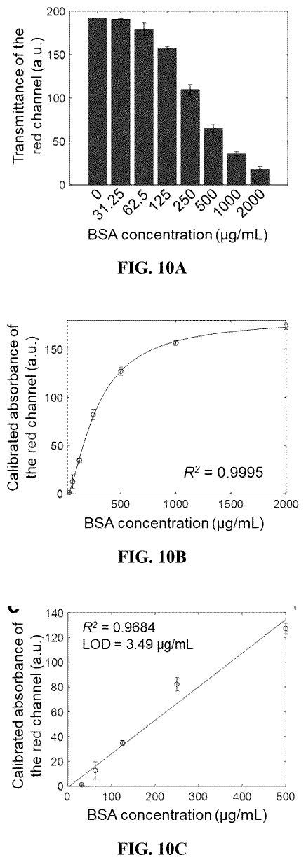

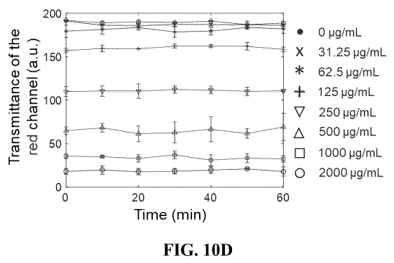

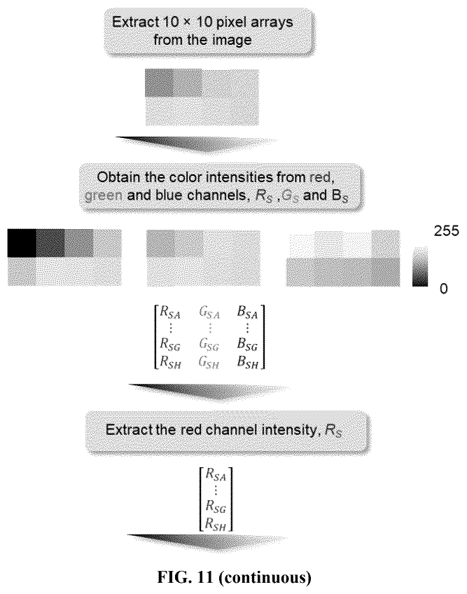

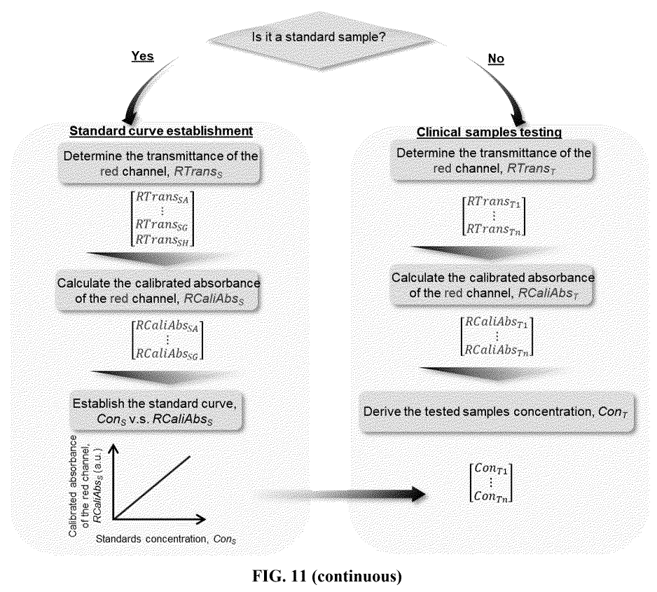

To calibrate the hand-held spinning centrifugal microfluidics system, eight standard BSA samples (2000, 1000, 500, 250, 125, 62.5, 31.25 μg/mL, and a blank) are analyzed by quantifying red-channel transmittance (FIG. 10A). Increasing BSA concentration results in a progressive decrease in red-channel transmittance due to the higher light-absorption capacity of concentrated BSA. To reduce background interference, the absorbance intensities of the standards are calibrated by subtracting the signal obtained from the blank sample (FIG. 11). The calibration curve is constructed using the four-parameter logistic (4-PL) regression model, which accurately captures the relationship between standard BSA concentration and the corrected red-channel absorbance intensity (FIG. 10B):

$$y = \frac{B - A}{1 + {( \frac{x}{C} )}^{D}} + A . \qquad ( 5 )$$

Herein, y denotes the response value, x represents the BSA concentration, A and B correspond to the maximum and minimum asymptotic absorbance values, and C and D represent the inflection point and the slope factor at the inflection point, respectively. The fitted parameter values for A, B, C, and D are −5.24, 181.27, 278.59, and −1.53 (Equation 5). The resulting correlation coefficient (R²=0.9995) demonstrates a highly robust fit, confirming the suitability of the model for subsequent quantitative analysis of clinical urine samples. The resulting calibration curve exhibits a dynamic range of 31.25-2000 μg/mL, fully encompassing the clinically relevant range of urinary total protein (e.g., <300 μg/mL for albuminuria assessment).

The system exhibits a performance behavior according to a linear regression formula:

$$y ( 0 - 500 \frac{μ g}{mL} ) = - 0.76 + 0.27 x$$

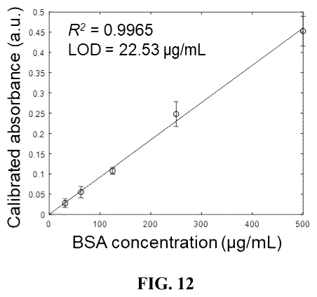

with a detection limit of 3.49 μg/mL, a limit of quantification of 5.05 μg/mL, and linear dynamic ranges of 5.05-500 μg/mL (FIG. 10C). Notably, the detection limit is approximately 6.45-fold lower than that of a commercial plate reader (22.53 μg/mL), while requiring only half the sample volume. This improvement reflects the system's reduced sample workload and strong potential for benchtop, instrument-free POC deployment (FIG. 12). The low detection limit demonstrates the successful optimization of illumination, imaging, and microfluidic parameters within the system.

The temporal stability of the colorimetric reaction is also evaluated across the standard BSA concentrations. Red-channel transmittance is measured at 10-minute intervals for seven standard BSA samples (FIG. 10D). The color intensities remain highly stable for at least 1 hour, with minimal fluctuation observed even in high-concentration samples, including the 2000 μg/mL (18.94±1.14, CV=6%), 1000 μg/mL (34.00±1.96, CV=5.76%), and 500 μg/mL (64.97±2.53, CV=3.90%) groups. These results confirm the high temporal stability of the assay for UTP detection. Furthermore, the reaction product remains securely confined within each microchannel owing to capillary pressure generated by the PDMS layer, effectively preventing backflow or cross-contamination between adjacent sample wells.

### Example 5. Clinical Validation of the System for UTP Detection

Subsequently, the hand-held spinning centrifugal microfluidics system is employed to detect UTP levels in clinical specimens. A total of 31 urine samples is collected, including 6 samples from healthy donors and 25 samples from patients following myocardial infarction (MI) surgery, based on their confirmed clinical diagnoses at the hospital. All urine samples from MI patients are obtained post-surgery.

Urine samples from healthy donors (n=6) are obtained from Innovative Research, and urine samples from patients following MI (n=25) are collected under clinical supervision. Urine specimens from post-MI patients are collected in plastic urine collection cups, transported to the laboratory, aliquoted into 2 mL tubes, and stored at −80° C. until analysis. Before testing, all samples are thawed to room temperature. The performance of the colorimetric-based detection method is assessed by comparing the protein concentrations quantified using the disclosed system with those measured by a commercial plate reader, which serves as the gold-standard reference.

In addition to direct visual inspection, urinary protein concentration is quantified through image-based analysis. Photographs of the reaction wells are captured using an iPhone 7 and processed using MATLAB software. With the chip disk positioned at a fixed location and a constant distance maintained between the smartphone and the chip, color intensities from each sample well are extracted from a defined 10×10-pixel region corresponding to the predetermined detection area. The pixel arrays are separated into individual red, green, and blue color channels, and the transmittance of the red channel is selected for quantitative analysis due to its superior dynamic range and sensitivity.

To minimize background interference, the red channel intensities of both standards and clinical samples are calibrated by subtracting the blank-sample intensity, yielding a calibrated absorbance value. The blank samples consist of distilled water processed under identical experimental conditions, including reaction with Coomassie dye. A calibration curve is subsequently constructed by fitting the calibrated intensities of the standard protein solutions using a 4-parameter logistic (4-PL) model. The urinary protein concentration of unknown samples is then determined by applying their calibrated red-channel intensities to the established 4-PL calibration curve.

For reference, urinary protein testing using a spectrophotometric method, calibrated standards, and clinical urine samples are analyzed in parallel. Specifically, 10 μL of each standard or sample and 200 μL of the colorimetric reagent are dispensed in triplicate into a 96-well transparent microtiter plate, and the reaction is allowed to proceed for 3 minutes. Before measurement, the plate is gently shaken for 5 seconds at room temperature to ensure uniform mixing. Absorbance is then recorded using a benchtop microplate reader operated in absorbance mode at a wavelength of 594 nm. This spectrophotometric assay serves as the gold standard for comparison with the handheld spinning centrifugal microfluidics system.

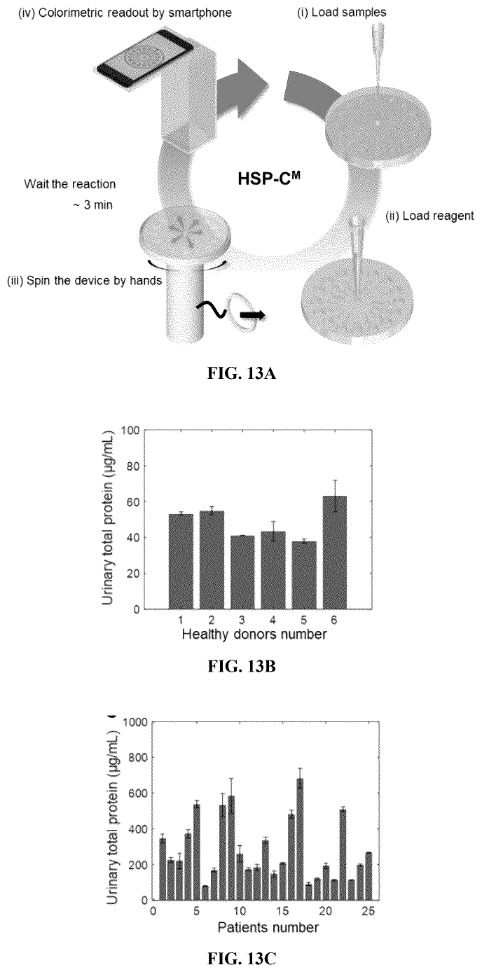

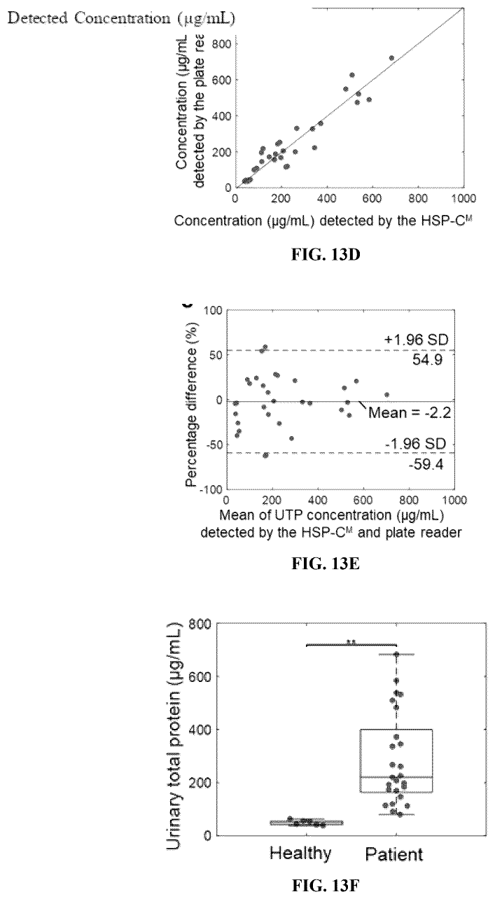

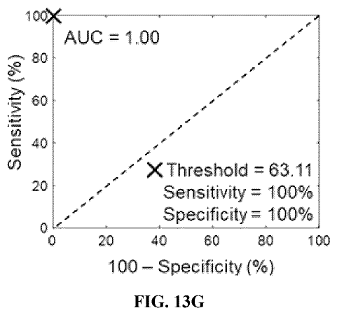

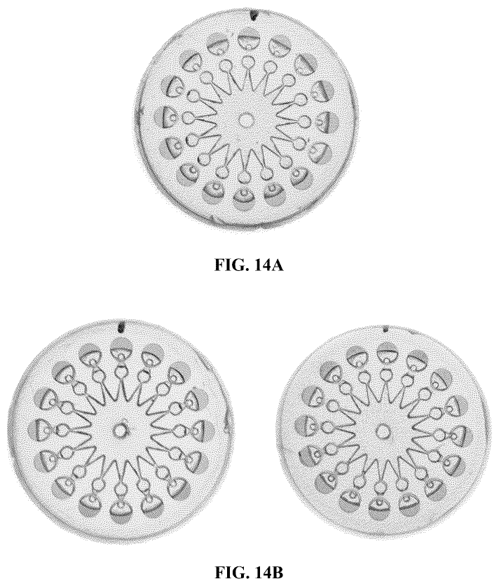

The samples are analyzed using both the disclosed system and a commercial plate reader in a standard 96-well format. Following the established testing protocol, 5 μL of each urine sample and 412 μL of G250 reagent are introduced into the chip disk (FIG. 13A). The finger ring of the spinning device is then pulled to distribute the reagent into the individual reaction chambers for colorimetric analysis, and the reaction proceeds for 3 minutes. Afterward, the reaction products are imaged using a smartphone operating at an exposure time of 1/100 s. UTP concentrations in all clinical samples are calculated based on the calibrated red-channel absorbance and the system's calibration curve. The chip accommodates simultaneous testing of up to 16 urine samples (FIGS. 14A-14B).

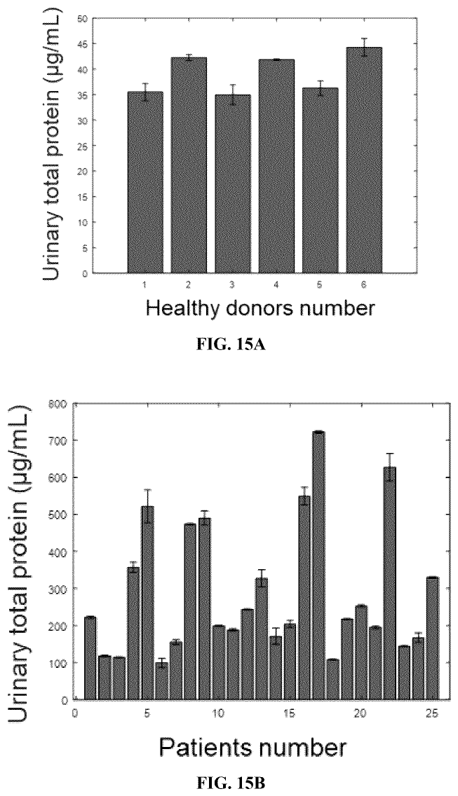

UTP levels in samples from healthy donors are significantly lower than those observed in MI patients (FIG. 13B and FIG. 13C). To assess the concordance between the disclosed system and the commercial plate reader (FIGS. 15A-15B), quantification results for the two cohorts are compared across both testing modalities (FIG. 13D). Linear regression analysis yields the following relationship:

$$y = - 5.31 + 1.01 x . \qquad ( 6 )$$

Where x represents UTP concentration measured by the commercial plate reader, and y represents UTP concentration measured by the disclosed system. The Spearman correlation coefficient is 0.902, indicating a strong monotonic correlation between the two techniques based on Passing-Bablok regression. Lin's concordance correlation coefficient is calculated as 0.9481, indicating a high level of agreement between measurements obtained from the system and those from the commercial plate reader.

To further evaluate agreement and potential systematic bias, a Bland-Altman analysis is performed (FIG. 13E). Differences between the two measurement methods are expected to fall within δ±1.96 s, where & denotes the mean difference and s represents the standard deviation. The analysis shows that 90.32% of the paired data points (healthy donors, n=6; post-MI patients, n=25) fall within these limits of agreement. The mean bias is −2.2%, with 95% confidence intervals ranging from −59.4% to 54.9%, suggesting that discrepancies between methods increase at higher UTP concentrations.

Together, the high concordance correlation coefficient (0.9481) and the 90.32% Bland-Altman agreement indicate that the system provides quantitative UTP measurements closely aligned with the gold-standard commercial plate reader, supporting its value as a POC diagnostic tool for monitoring proteinuria.

To explore the clinical relevance of UTP quantification in differentiating healthy donors from post-MI patients, UTP concentrations across the two groups are compared, and diagnostic thresholds are established using ROC analysis. UTP levels are significantly elevated in the patient group compared with the healthy donor group (p<0.01) (FIG. 13F), indicating that increased UTP is associated with a higher likelihood of post-MI or unhealthy physiological status.

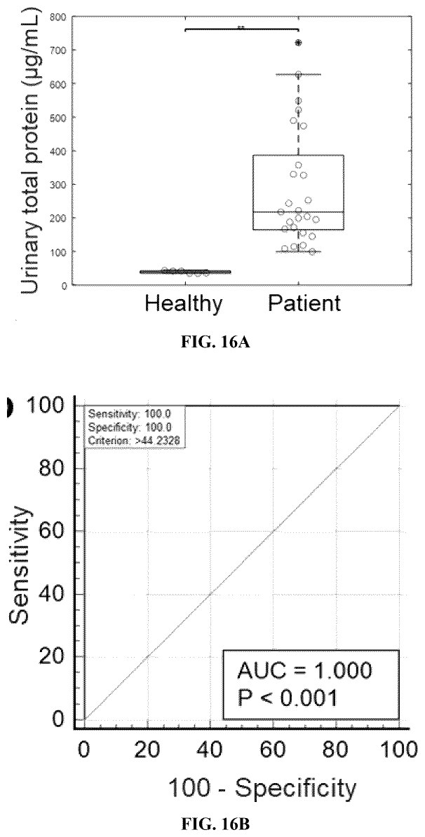

ROC curves are used to determine optimal thresholds for distinguishing the two cohorts (FIG. 13G). The area under the curve (AUC) is calculated as 1, indicating perfect discriminatory performance. Thresholds are derived using Youden's index, which maximizes the sum of sensitivity and specificity. At a threshold of 63.11 μg/mL, UTP achieves 100% sensitivity and 100% specificity for identifying MI patients. These optimal AUC, sensitivity, and specificity values affirm the clinical significance of urinary protein as a biomarker for differentiating healthy individuals from patients at elevated risk of MI using a readily interpretable cutoff (>63.11 μg/mL). Comparable classification performance is observed when using the commercial plate reader (FIGS. 16A-16B).

Collectively, these results underscore the utility of the hand-held centrifugal microfluidics system as a robust and effective POC platform for disease monitoring, particularly for proteinuria assessment in resource-limited environments.

The present invention provides a portable, electricity-free, hand-held analytical platform for quantifying medically significant protein levels, such as UTP, in clinical patients. The system incorporates a disposable centrifugal microfluidic chip disk, used in conjunction with a manually operated spinning device, which enables uniform reagent and sample distribution through precise adjustment of the microchannel aspect ratios. A calibration curve established using standard protein samples demonstrates excellent stability, a broad dynamic range, and a low detection limit when operated under optimized system parameters, including exposure time, sample loading volume, and selected color channel for quantitative analysis. The protein quantification results obtained using the disclosed method exhibit strong correlation and high agreement with measurements generated by a commercial plate reader.

Moreover, the present invention reveals significantly elevated UTP levels in the urine of post-MI patients compared with healthy donors. It establishes clinically meaningful threshold values that accurately distinguish between these two cohorts. Collectively, these results demonstrate that the disclosed portable urinalysis platform offers substantial potential for POC disease monitoring, particularly in resource-limited or decentralized healthcare settings.

The functional units and modules, such as the processors, of the system and/or methods in accordance with the embodiments disclosed herein may be implemented using computing devices, computer processors, or electronic circuitries including but not limited to application specific integrated circuits (ASIC), field programmable gate arrays (FPGA), microcontrollers, graphical processing units (GPU), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of +10%, +5%, +1%, or +0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within +10%, +5%, +1%, or +0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A hand-held spinning centrifugal microfluidics system, comprising:
a spinning device;
a centrifugal microfluidic chip disk with an upper layer and a bottom layer, wherein the upper layer is hydrophobic and comprises:
a plurality of reaction chambers configured to accommodate a biological fluid sample, each reaction chamber comprising a venting and sample-loading hole for receiving the biological fluid sample; and
a reagent-loading chamber comprising an introducing port configured to introduce a colorimetric dye, a container configured to retain the colorimetric dye, and a plurality of radial side-tubes connecting the reagent-loading chamber to the respective reaction chambers and configured to deliver the colorimetric dye into the reaction chambers;
wherein the reagent-loading chamber is located at a central region of the upper layer, the reaction chambers are arranged radially around the reagent-loading chamber, and the number of radial side-tubes equals the number of reaction chambers;
wherein the bottom layer comprises a hydrophilic surface forming a floor of the centrifugal microfluidic chip disk and configured to promote uniform spreading of the biological fluid sample and the colorimetric dye; and
wherein the radial side-tubes comprise a microchannel structure having a deliberate geometric transition from a high aspect ratio to a low aspect ratio to increase local hydrophilicity and induce capillary pressure sufficient to prevent premature flow of the colorimetric dye before spinning;
an illumination device configured to illuminate the reaction chambers;
an image acquisition module configured to acquire images of the illuminated reaction chambers; and
a controller comprising one or more processors, the processors being configured to:
control the illumination device to illuminate the reaction chambers;
control the image acquisition module to obtain the images;
extract one or more colorimetric intensity values from images of the reaction chambers;
calibrate the extracted intensity values using a calibration curve established from standard protein samples; and
determine a protein concentration in the biological fluid sample based on the calibration curve;
wherein the centrifugal microfluidic chip disk is detachably mounted on the spinning device such that rotation of the spinning device generates a centrifugal force; and
wherein the colorimetric dye contained in the container flows into the reaction chambers via the radial side-tubes when the centrifugal microfluidic chip disk is spinning.

2. The hand-held spinning centrifugal microfluidics system of claim 1, wherein the geometric transition comprises a reduction in microchannel height, width, or both, to produce a higher capillary pressure downstream of the transition to regulate reagent flow.

3. The hand-held spinning centrifugal microfluidics system of claim 2, wherein the deliberate geometric transition from the high aspect ratio to the lower aspect ratio, from the reagent-loading chamber towards the reaction chambers, creates a capillary bursting valve that retains the colorimetric dye within the reagent-loading chamber until the centrifugal force generated during spinning exceeds a predetermined threshold.

4. The hand-held spinning centrifugal microfluidics system of claim 1, wherein the bottom layer comprises a glass substrate plasma-treated to enhance surface wettability.

5. The hand-held spinning centrifugal microfluidics system of claim 1, wherein the upper layer is configured to inhibit lateral spreading of liquid along channel walls and comprises polydimethylsiloxane (PDMS), polyurethane, silicone elastomer, thermoplastic elastomer (TPE), and ethylene-vinyl acetate (EVA).

6. The hand-held spinning centrifugal microfluidics system of claim 1, wherein the reaction chambers are configured to prevent back-flow by capillary retention induced by the hydrophobic-hydrophilic interface between the upper layer and the bottom layer.

7. The hand-held spinning centrifugal microfluidics system of claim 1, wherein the calibration curve is a four-parameter logistic (4-PL) fitting curve generated using standard protein solutions spanning 0-2000 μg/mL.

8. The hand-held spinning centrifugal microfluidics system of claim 7, wherein the standard protein solutions comprise a series of a desired protein diluted in the colorimetric dye at different concentrations.

9. The hand-held spinning centrifugal microfluidics system of claim 1, wherein the controller is further configured to correct the extracted color intensities by subtracting blank-sample intensities to obtain calibrated absorbance values.

10. The hand-held spinning centrifugal microfluidics system of claim 1, wherein the image acquisition module comprises a camera positioned at a fixed distance above the centrifugal microfluidic chip disk.

11. The hand-held spinning centrifugal microfluidics system of claim 1, wherein the controller selects the red channel of the captured images for quantitative analysis and color complementarity of the colorimetric dye.

12. The hand-held spinning centrifugal microfluidics system of claim 1, wherein the spinning device comprises a hand-pull ring configured to generate centrifugal pressure without electrical power.

13. A method for quantifying a desired protein concentration using the system of claim 1, comprising:
applying a biological fluid sample to venting and sample-loading holes of the reaction chambers;
introducing a colorimetric dye solution into the reagent-loading chamber;
spinning the microfluidic chip to distribute the colorimetric dye solution into the reaction chambers;
illuminating the reaction chambers using the illumination device and acquiring images using the image acquisition module;
extracting colorimetric intensities and converting them into absorbance values; and
applying a calibration curve established from standard desired protein samples to determine the protein concentration in the biological fluid sample.

14. The method of claim 13, wherein the desired protein reacts colorimetrically with the colorimetric dye solution.

15. The method of claim 13, wherein spinning is performed manually using a hand-operated pull-ring mechanism to generate centrifugal forces exceeding the capillary bursting threshold of the microchannel aspect-ratio transition.

16. The method of claim 13, wherein the calibration curve is stored in the controller memory for real-time clinical testing.

17. The method of claim 13, wherein the biological fluid sample comprises urine from a patient suspected of having proteinuria.
